(19) United States
(12) Patent Application Publication
(10) Pub. No.: US 2016/0169264 A1
(43) Pub. Date: Jun. 16, 2016

(54) CAGE STUD ASSEMBLY AND RELATED ASSEMBLY METHODS

(71) Applicant: NEWFREY LLC, Newark, DE (US)

(72) Inventor: Raymond M. Genick, II, Harrison Township, MI (US)

(73) Assignee: NEWFREY LLC, Newark, DE (US)

(21) Appl. No.: 14/566,199

(22) Filed: Dec. 10, 2014

(51) Int. Cl. F16B 37/04

(52) U.S. Cl. CPC F16B 37/044

(57) ABSTRACT

In accordance with a first aspect of the present disclosure, a method of assembling a first automobile component relative to a second automobile component is provided. The method includes providing a cage fastener assembly that includes a cage and a first fastener. The cage includes a cavity, and the first fastener includes a head portion and a threaded shank portion. The head portion is at least partially disposed within the cavity. The threaded shank portion extends from the cavity along a longitudinal axis. The method also includes fixedly coupling the cage to the first automobile component such that the longitudinal axis extends in a substantially horizontal direction during first and second automobile component assembly. The method further includes positioning the threaded shank portion through an aperture of the second automobile component such that a full weight of the second automobile component is supported by the shank.

### FIELD

The present disclosure relates to a cage stud assembly and related methods of using a cage stud assembly.

### BACKGROUND

This section provides background information related to the present disclosure and is not necessarily prior art.

Cage fastener assemblies can be used to couple, mount or otherwise connect various components. For example, a cage nut assembly can be used in an automobile or other vehicle to mount a component or subassembly to a body or other portion of the vehicle. The cage nut assembly can include a cage that houses a threaded nut. Methods of assembling first and second components with a cage nut assembly can include coupling or mounting the cage to the first component, and thereafter coupling a threaded bolt to the second component. The threaded bolt and the second component can then be coupled to the threaded nut and the first component by aligning and coupling the threaded bolt with the threaded nut. Aligning a bolt to a cage nut can be quite difficult. In some cases, the threaded nut is concealed by portions of the first component, by the second component through which the threaded bolt passes, or an intermediate component. Accordingly, it can be difficult to visually align and couple the threaded nut with the threaded bolt. In some cases, the weight of the second component must be supported by a person or machine while the threaded bolt is being aligned and coupled with the threaded nut, which also impedes alignment and threading.

It would be desirable to provide a new cage stud assembly and related method of use that facilitates easier alignment and threading of threaded fasteners, including a nut and cage stud assembly, in a variety of mounting applications.

### SUMMARY

This section provides a general summary of the disclosure, and is not a comprehensive disclosure of its full scope or all of its features.

In accordance with a first aspect of the present disclosure, a method of assembling a first automobile component relative to a second automobile component is provided. The method includes providing a cage fastener assembly that includes a cage and a first fastener. The cage includes a base portion and an arm portion defining a cavity. The first fastener includes a head portion at least partially disposed within the cavity and a threaded shank portion coupled to the head portion. The threaded shank portion extends from the cavity along a longitudinal axis. The method also includes fixedly coupling the cage to the first automobile component such that the longitudinal axis extends in a substantially horizontal direction during first and second automobile component assembly. The method further includes positioning the threaded shank portion through an aperture of the second automobile component such that a full weight of the second automobile component is supported by the shank. After supporting the second automobile component on the shank, the method also includes rotating a cooperating threaded fastener onto the threaded shank of the first fastener such that the first automobile component is fixedly coupled in a desired position relative to the second automobile component.

In accordance with another aspect of the present disclosure, a method of assembling a first automobile component relative to a second automobile component is provided. The method includes providing a cage fastener assembly that includes a cage and a first fastener. The cage includes a base portion and an arm portion defining a cavity. The first fastener includes a head portion at least partially disposed within the cavity and a threaded shank portion coupled to the head portion. The threaded shank portion extends from the cavity along a longitudinal axis. The method also includes fixedly coupling the cage to the first automobile component. The method further includes providing an intermediate automobile component over the cage fastener assembly such that the threaded shank portion visibly extends into the intermediate automobile component, while the cage is visibly obscured by the intermediate automobile component. The method also includes positioning the threaded shank portion through an aperture of the second automobile component such that the positioning is aided by visibly locating the threaded shank extending through the intermediate automobile component. The method further includes rotating a cooperating threaded fastener onto the threaded shank of the first fastener such that the first automobile component is fixedly coupled in a desired position relative to the second automobile component.

In accordance with yet another aspect of the present disclosure, a method of assembling a first vehicle component relative to a second vehicle component is provided. The method includes providing a cage fastener assembly, including a cage portion and a first fastener retained within the cage portion. The first fastener includes a threaded shank extending from the cage along a longitudinal axis. The cage portion includes wings extending laterally from the cage portion. The method also includes riveting the wings to the first component with a self-piercing rivet such that the longitudinal axis extends in a substantially horizontal direction. The method further includes coupling the second vehicle component to the first fastener such that a weight of the second vehicle component is applied to the first fastener in a direction transverse to the longitudinal axis. The method also includes coupling a second fastener to the first fastener such that first vehicle component is fixed relative to the second vehicle component.

In accordance with a further aspect of the present disclosure, a cage fastener assembly is provided. The cage fastener assembly can include a cage and stud. The cage can include a base portion and a pair of arm portions. The base portion and the pair of arm portions can define a cavity. The base portion can further define a first longitudinally extending width, and the arm portions can each define a second longitudinally extending width that is less than the first longitudinally extending width. The stud can include a head portion and a shank portion. The head portion can be at least partially disposed within the cavity of the cage. The shank portion can extend through the base portion of the cage.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a first perspective view of a cage bolt assembly in accordance with the principles of the present disclosure.

FIG. 2 is a second perspective view of the cage bolt assembly of FIG. 1.

FIG. 3 is a front-side view of the cage bolt assembly of FIG. 1.

FIG. 4 is a cross-sectional view of the cage bolt assembly of FIG. 1 taken through line 4-4 of FIG. 3.

FIG. 5A is a side elevation view of the cage bolt assembly of FIG. 1 being used in a first method of joining parts of a vehicle.

FIG. 5B is a side elevation view of the cage bolt assembly of FIG. 1 being used in the first method of joining parts of a vehicle.

FIG. 5C is a side elevation view of the cage bolt assembly of FIG. 1 being used in the first method of joining parts of a vehicle.

FIG. 6A is a side elevation view of the cage bolt assembly of FIG. 1 being used in a second method of joining parts of a vehicle.

FIG. 6B is a side elevation view of the cage bolt assembly of FIG. 1 being used in the second method of joining parts of a vehicle.

FIG. 6C is a side elevation view of the cage bolt assembly of FIG. 1 being used in the second method of joining parts of a vehicle.

Corresponding reference numerals indicate corresponding parts throughout the several views of the drawings.

### DETAILED DESCRIPTION

Example embodiments will now be described more fully with reference to the accompanying drawings.

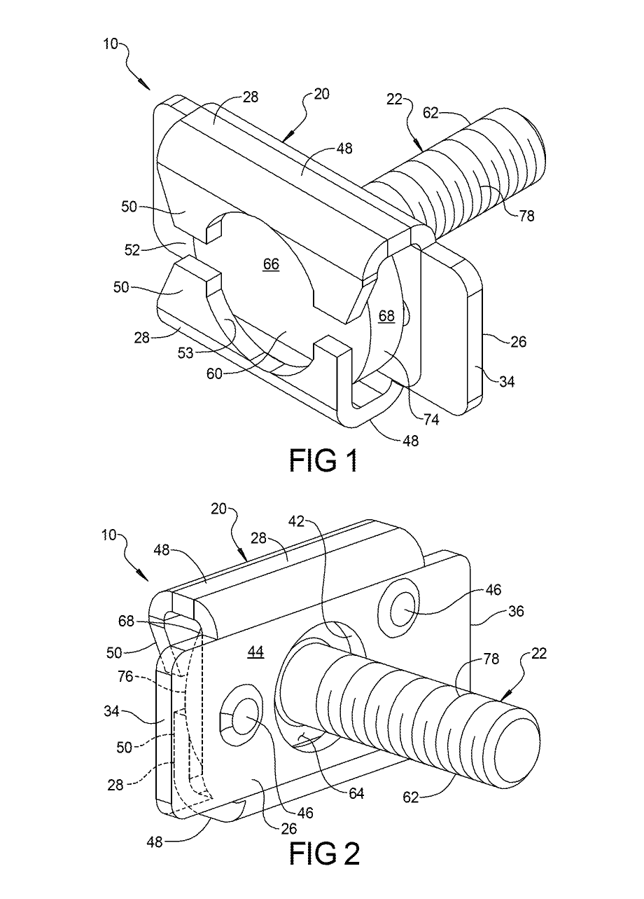

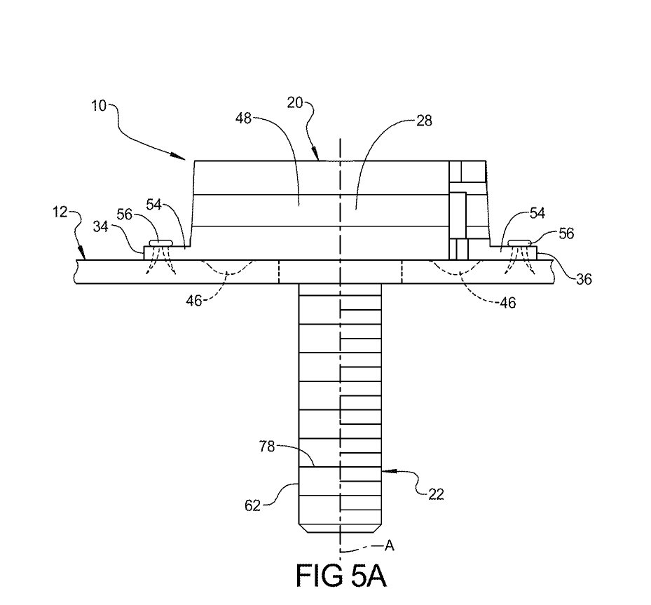

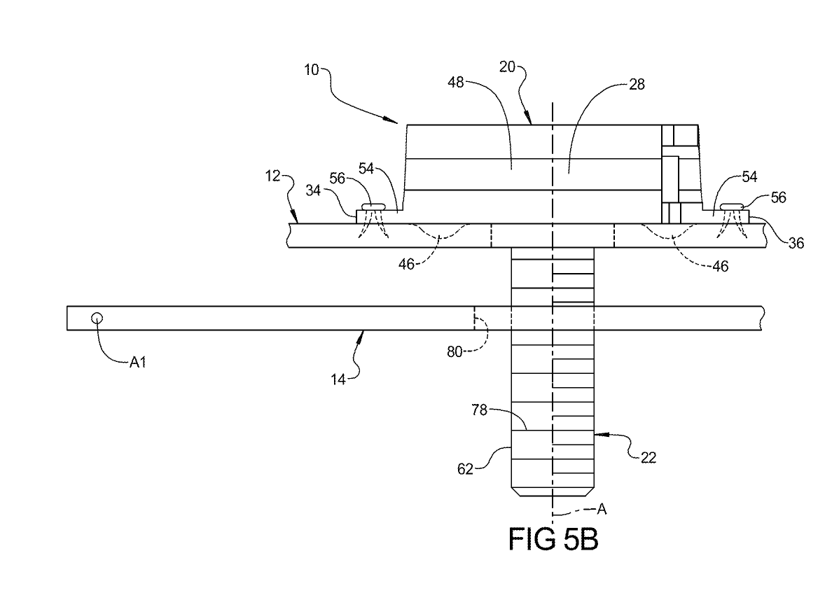

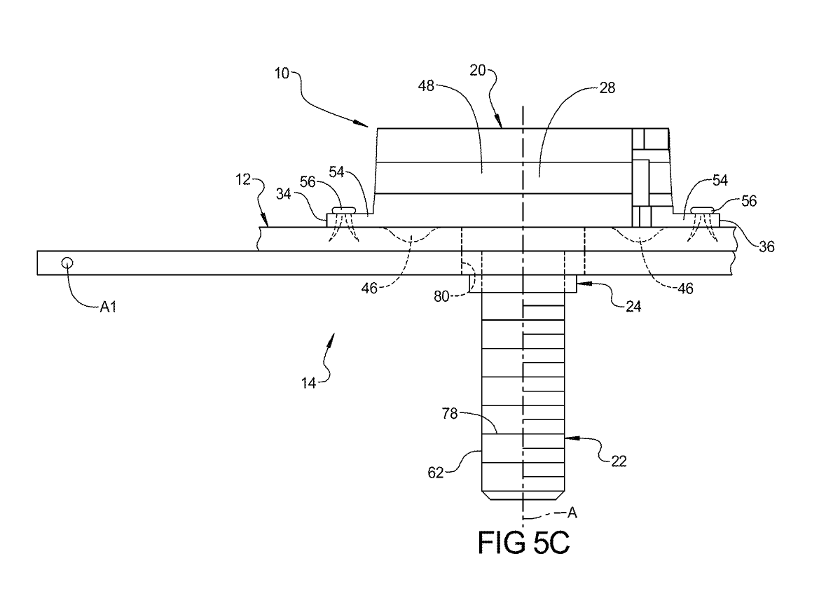

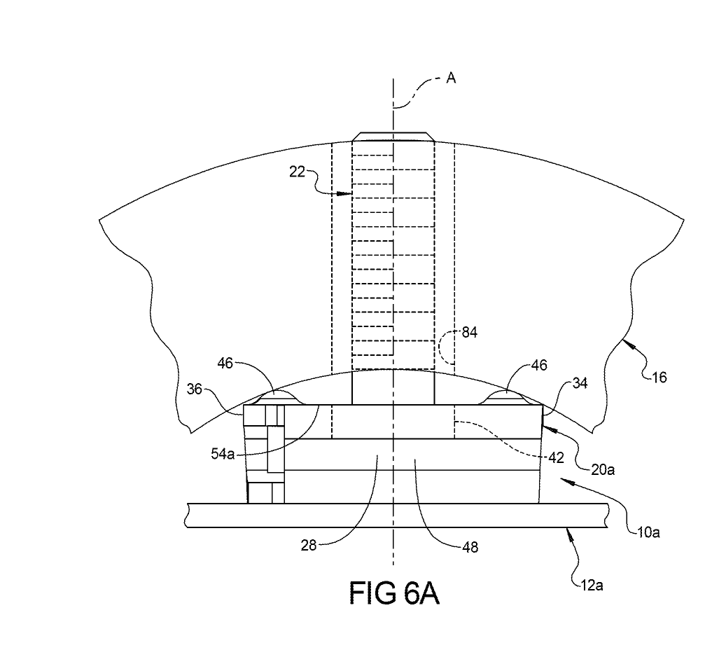

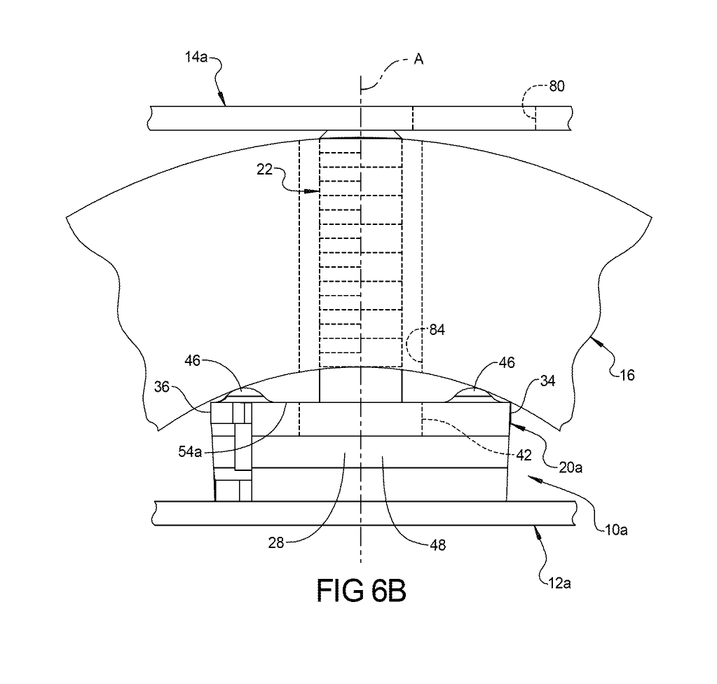

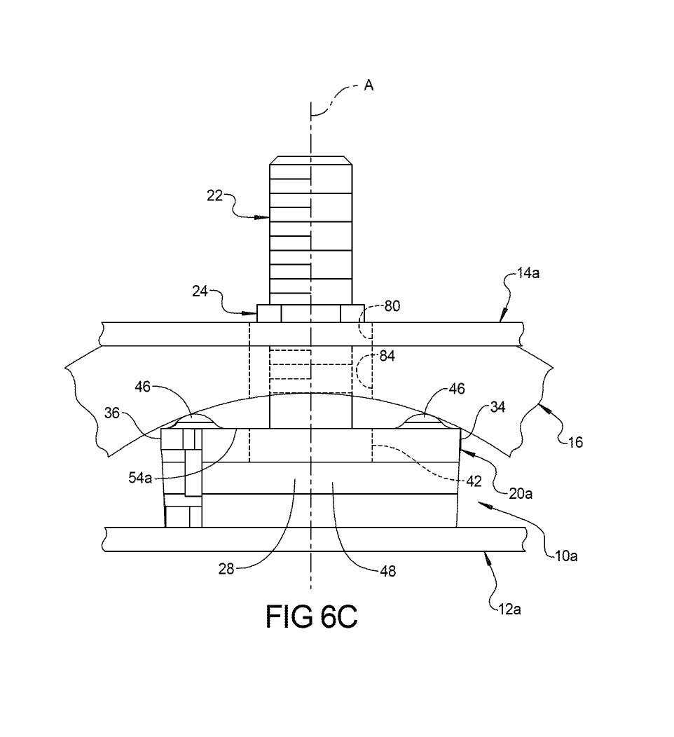

With reference to FIGS. 1-4, a cage fastener assembly constructed in accordance with the present disclosure is illustrated and identified at reference 10. As illustrated in FIGS. 5A-5C and 6A-6C, in some configurations the tethered fastener assembly 10 may be used in an automobile (not shown) or other similar vehicle to join a first component 12 to a second component 14, and/or to a third or intermediate component 16. According to one exemplary use (e.g., FIG. 5A), the first component 12 includes a vehicle frame or body and the second component 14 includes a vehicle door, or a portion thereof, such as a hinge member. According to another exemplary use, the first component 12 includes a vehicle frame or body and the second component 14 includes a vehicle seat, or portion thereof, and the intermediate component 16 includes a material such as carpet, carpet padding (e.g., foam, insulation, or other suitable fabric). It will be appreciated, however, that the present teachings may be adapted to join various components in the automobile.

The cage fastener assembly 10 can include a cage 20, a stud fastener 22, and a second or cooperating nut fastener 24. As will be explained in more detail below, a portion of the stud fastener 22 is adjustably retained within the cage 20. Accordingly, the cage 20 can be coupled to any of the first, second and intermediate components 12, 14, 16, and the stud fastener 22 can be coupled to another of the first, second and intermediate components 12, 14, 16, such that the first, second and/or intermediate component(s) 12, 14, 16 is coupled to the other(s) of the first, second and/or intermediate components 12, 14, 16. In this regard, in some configurations, the stud fastener 22 comprises a threaded bolt, and the nut fastener 24 may include a threaded nut, such that the nut fastener 24 can threadably engage the stud fastener 22.

The cage 20 can include a base portion 26 and a pair of arm portions 28. The base portion 26 can be integrally formed with the arm portions 28, such that the cage 20 includes a monolithic or unitary construct. In this regard, it will be appreciated that the cage 20 may be manufactured by stamping, casting, machining, additive manufacturing, or other suitable process. In this regard, in some configurations the cage 20 may be formed from steel (e.g., high strength low alloy steel), aluminum, or another metallic material that is suitable for self-piercing rivet applications, as will be discussed in more detail below. With reference to FIG. 4, the base portion 26 and the arm portions 28 define a cavity 30.

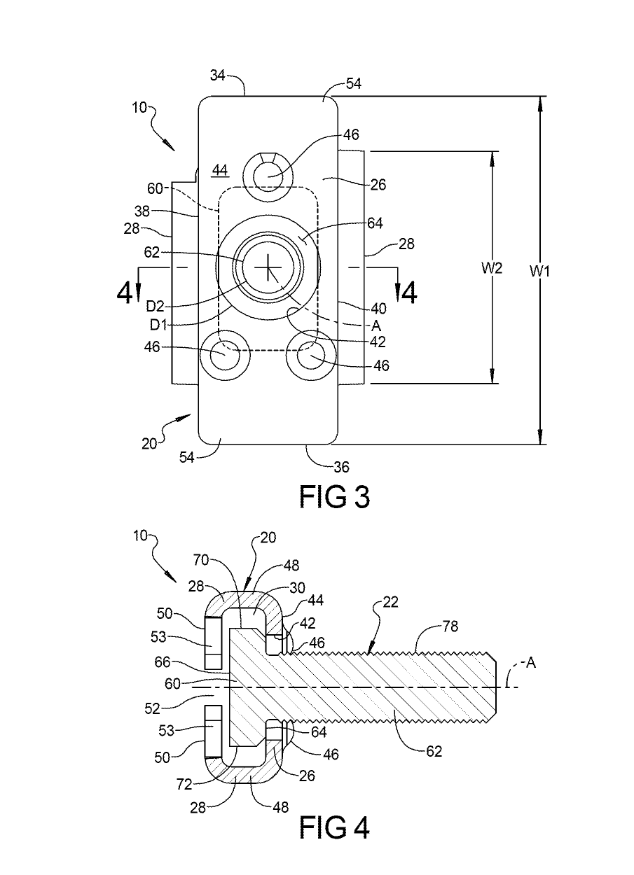

As illustrated in FIG. 3, the base portion 26 can include first and second ends 34, 36, first and second transition portions 38, 40 and a through-hole or aperture 42. The first end 34 is opposite the second end 36 such that the first and second ends 34, 36 define a longitudinally extending width W1 therebetween. The first and second transition portions 38, 40 can extend substantially perpendicularly from and between the first and second ends 34, 36. The aperture 42 can extend through the base portion 26 and define a minimum dimension D1. In some configurations, the aperture 42 may include a generally circular shape such that the dimension D1 defines a diameter of the aperture 42.

A component-engaging surface 44 of the base portion 26 can extend from and between the first and second ends 34, 36 and the first and second transition portions 38, 40. As illustrated in FIG. 4, the component-engaging surface 44 is opposite the cavity 30 and includes at least one engagement feature 46 extending therefrom. As illustrated in FIG. 3, in some configurations the component-engaging surface 44 can include three engagement features 46, such that the aperture 42 is disposed between, and generally centrally located relative to, the engagement features 46. As will be explained in more detail below, the engagement features 46 can include a substantially hemispherical shape or profile to engage one of the first, second and intermediate components 12, 14, 16 in an assembled configuration.

The arm portions 28 extend from the first and second transition portions 38, 40 of the cage 20, and include a proximal portion 48 and a distal portion 50. The proximal portion 48 can extend from the base portion 26, and the distal portion 50 can extend from the proximal portion 48. As illustrated, the proximal portions 48 can be generally parallel to one another and generally perpendicular to the base portion 26. The distal portions 50 can be generally parallel to one another and the base portion 26, and generally perpendicular to the proximal portions 48. In this regard, as illustrated in FIG. 4, the arm portions 28 can each include, or otherwise define, a generally L-shaped construct, and together with the base portion 26 define a U-shaped construct.

With reference to FIGS. 1 and 4, the distal portion 50 of a first of the arm portions 28 and the distal portion 50 of a second of the arm portions 28 can define a void or gap 52 therebetween. In this regard, the arm portions 28 can include arcuately-shaped recesses 53 such that the gap 52 includes a generally circularly-shaped central portion. In some configurations, a portion (not shown) of the stud fastener 22 can be disposed within, or otherwise extend through, the gap 52.

With reference to FIG. 3, the arm portions 28 can define a laterally extending width W2 that is less than the longitudinally extending width W1 of the base portion 26. Accordingly, the base portion 26 can include, or otherwise define, wing portions 54 extending laterally beyond the width W2 of the arm portions 28. As will be explained in more detail below, the wing portions 54 can help to secure the cage 20 to the first component 12 (FIG. 5A). Specifically, a rivet 56 (e.g., a self-piercing rivet) can be inserted through the wing portions 54 and into the first component 12 to secure the cage 20 to the first component. It will also be appreciated that other fastening techniques (e.g., screw, bolt, welding, adhesive, etc.) can be used to secure the wing portions 54, and thus the cage 20, to the first component 12.

The stud fastener 22 includes a head portion 60 and a threaded shank portion 62. In some configurations, the shank portion 62 can be integrally and monolithically formed with the head portion 60 by casting, machining, additive manufacturing, or other suitable manufacturing process. In other configurations the shank portion 62 can be mechanically fastened to the head portion 60 by threading, press-fitting, welding, or other suitable fastening technique. In this regard, in some configurations the stud fastener 22 may include an ASTM F568M Class 10.9 bolt that includes quenched and tempered steel (e.g., alloy steel, carbon steel, stainless steel, etc.), suitable for high load applications.

With reference to FIGS. 1, 3, and 4, the head portion 60 can include an anterior surface 64, a posterior surface 66, and a peripheral surface 68. The peripheral surface 68 can extend from and between the anterior and posterior surfaces 64, 66. As illustrated, in an assembled configuration, the anterior surface 64 can face the base portion 26 of the cage 20, and the posterior surface 66 can face the distal portion 50 of the arm portions 28. The anterior surface 64 can include a generally planar construct. In an assembled configuration, the head portion 60 can be disposed within the cavity 30 such that the anterior surface 64 can slidably engage the base portion 26, while the posterior surface 66 can slidably engage the distal portions 50 of the arm portions 28.

With reference to FIGS. 1, 2 and 4, the peripheral surface 68 of the head portion 60 can include opposed lateral portions 70, 72 and opposed end portions 74, 76. The lateral portions 70, 72 can include a planar construct, while the end portions 74, 76 can include an arcuate (e.g., convex) construct. In this regard, the peripheral surface 68 can define a generally stadium-shaped construct. The stadium-shaped construct of the head portion 60 can allow the head portion 60 to slide or otherwise move more easily within the cage 20 and the cavity 30. Specifically, in an assembled configuration, at least one of the lateral portions 70, 72 can slidably engage, or otherwise be supported by, at least one of the proximal portions 48 of the arm portions 28.

With reference to FIGS. 4 and 5A, the shank portion 62 can extend from the head portion 60 along a longitudinal axis A. The shank portion 62 can include a plurality of threads 78. As illustrated in FIG. 3, the shank portion 62 can define a maximum dimension D2 extending in a direction substantially perpendicular to the axis A. In some configurations the shank portion 62 can include a substantially cylindrical construct such that the maximum dimension D2 defines a diameter of the shank portion 62. As illustrated, the maximum dimension D2 is less than the minimum dimension D1 of the aperture 42. Accordingly, in an assembled configuration, the shank portion 62 can be disposed within, and can extend through, the aperture 42. In this regard, the maximum dimension D2 may be between forty percent and eighty percent of the minimum dimension D1 of the aperture 42. Thus, it will be appreciated that, in the assembled configuration, the position or location of the shank portion 62 relative to the aperture 42 can be adjusted or otherwise moved in a direction substantially perpendicular to the axis A.

As indicated above, the cage fastener assembly 10 can be used to assemble the first component 12 to the second and/or intermediate components 14, 16. With reference to FIGS. 5A-5C, in some configurations the cage 20 can be coupled to the first component 12 such that the longitudinal axis A extends in a substantially horizontal direction. In this regard, the base portion 26 can be riveted, welded, or otherwise fastened, to the first component 12. Specifically, in some configurations, the rivet 56 (e.g., self-piercing rivet 56) can extend through the wing portions 54 of the base portion 26 and into or through the first component 12. It will be appreciated that in some configurations the first component 12 may include a plurality of cage fastener assemblies 10 coupled thereto.

With reference to FIG. 5B, in assembling the second component 14 to the first component 12 and the cage fastener assembly 10, the shank portion 62 can be extended through an aperture 80 of the second component 14 such that a full weight of the second component 14 and/or a full weight of the stud fastener 22 is supported by the shank portion 62. In this regard, it will be appreciated that the configuration of the cage fastener assembly 10, including the shank portion 62 visibly extending through the first component 12, can make it easier for an assembler (e.g., a person, robot, or other machine) to align the shank portion 62 with the aperture 80.

It will be appreciated that in some configurations the weight of the second component 14 and/or the stud fastener 22 can extend in a direction substantially perpendicular to the axis A. Accordingly, the assembler may disengage from, or otherwise let go of, the second component 14 in order to pick up or otherwise grab the nut fastener 24 and/or a tool(s) for engaging the nut fastener 24. The configuration of the cage fastener assembly 10, including the shank portion 62, can ensure that the aperture 42 of the first component 12 remains aligned with the aperture 80 of the second component 14, and that the shank portion 62 remains aligned with both of the apertures 42 and 80, when the assembler disengages either or both of the first and second components 12, 14 prior to engaging the nut fastener 24 with the stud fastener 22. As indicated above, in some configurations, the first component 12 can be a body or frame portion of the vehicle, while the second component 14 can be a door of the vehicle, or portion thereof, having an axis of rotation A1 (FIG. 5A). The axis of rotation A1 may be substantially perpendicular to the longitudinal axis A of the shank portion 62. Accordingly, it will be appreciated that the door of the vehicle can hang from the shank portion 62 of the cage fastener assembly 10, such that both the first and second components 12, 14 are rotatable about the axis of rotation A1.

While the weight of the second component 14 is supported by the shank portion 62, and while the assembler remains disengaged from either or both of the first and second components 12, 14, the shank portion 62 can be coupled to the nut fastener 24. In this regard, it will be appreciated that the configuration of the cage fastener assembly 10, including the shank portion 62 visibly extending through the first component 12, can make it easier for the assembler to not only align the shank portion 62 with the aperture 80, but also to couple the shank portion 62 to the nut fastener 24 without having to support the second component 14 (e.g., without having to support the weight of the second component). In some configurations the nut fastener 24 may include a threaded nut, such that the nut fastener 24 is rotated to threadably engage the threads 78 of the shank portion 62.

With reference to FIG. 5C, in some configurations the nut fastener 24 may be rotated until the nut fastener 24 loosely engages, or is otherwise loosely positioned against, the second component 14, and/or until the second component 14 loosely engages, or is otherwise loosely positioned against, the first component 12. With the nut fastener 24 loosely engaging the second component 14, and/or the second component 14 loosely engaging the first component 12, the second component 14 can be moved parallel to, perpendicular to, and around the axis A. For example, as illustrated in FIG. 5C, the second component 14 can be moved such that the stud fastener 22 is centered relative to the aperture 80. After the second component 14 has been moved into a desired position, the nut fastener 24 may be rotated until the first component 12 is fixed or otherwise secured in a desired position relative to the second component 14. In this regard, it will also be appreciated that, if the first component 12 includes a plurality of cage fastener assemblies 10, as discussed above, additional nut fasteners 24 can be threadably coupled to the additional stud fasteners 22 to further secure the first component 12 relative to the second component 14.

With reference to FIG. 6A-6C, in some configurations a cage 20a of a cage fastener assembly 10a can be coupled to a first component 12a in any appropriate manner, including any manner described above. The cage 20a and the cage fastener assembly 10a are substantially similar to the cage 20 and cage fastener assembly 10, except as otherwise provided herein. Therefore, the structure and/or function of similar features will not be described again in detail. In addition, like reference numerals are used hereinafter and in the drawings to identify like components, while like reference numerals containing letter extensions (i.e., “a”) are used to identify those components that have been modified in the drawings. In this regard, a base portion 26a of the cage 20a may be formed without the wing portions 54 illustrated in FIGS. 1-4. As illustrated in FIG. 6A, the intermediate component 16 can be placed or otherwise positioned over the cage fastener assembly 10 such that the shank portion 62 visibly extends through an aperture 84 of the intermediate component 16 at least when partially compressing the intermediate component 16. In this regard, the cage 20 may be visibly obscured by the intermediate component 16. As indicated above, the intermediate component 16 may be a compressible material such as carpet, carpet padding, and/or insulation, for example.

With reference to FIG. 6B, the second component 14a may be placed on top of the cage fastener assembly 10a such that the full weight of the second component 14a is supported by the stud fastener 22. In this regard, it will be appreciated, that an aperture 80a may be misaligned relative to the stud fastener 22, as illustrated in FIG. 6B, such that the weight of the second component 14a extends in a direction substantially parallel to the axis A. As previously described, the second component 14a may be an automobile seat.

With reference to FIG. 6C, the shank portion 62 of the stud fastener 22 may then be positioned within the aperture 80a of the second component 14a, in the manner described above. Specifically, the second component 14a can be moved relative to the first component 12a in a direction parallel to, perpendicular to, and/or about the axis A such that the stud fastener 22 is aligned with the aperture 80a. When the stud fastener 22 is aligned with the aperture 80a, the weight of the second component 14a can allow the second component 14a to automatically fall, or otherwise move, toward the first component 12a. Positioning the stud fastener 22 within the aperture 80a can be aided by visibly locating the shank portion 62 extending through the intermediate component 16. It will be appreciated that positioning the stud fastener 22 within the aperture 80a can help to couple the first component 12a to the second component 14a and to the intermediate component 16 prior to coupling the nut fastener 24 to the stud fastener 22. In other words, the shank portion 62 can be extended through the first, second and intermediate components 12a, 14a, 16 without having to thread or otherwise couple the nut fastener 24 to the stud fastener 22. This allows for the aperture 42 of the first component 12a to be secured into alignment with the aperture 80a of the second component 14a and with the aperture 84 of the intermediate component 16, without having to couple the nut fastener 24 to the stud fastener 22.

Once the stud fastener 22 has been positioned within the aperture 80a, the second component 14a can be further moved or otherwise adjusted relative to the first component 12a in the manner described above. The nut fastener 24 can also be coupled to the stud fastener 22 in the manner described above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth, such as examples of specific components, devices and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. A method of assembling a first automobile component relative to a second automobile component, the method comprising:
providing a cage fastener assembly that includes a cage and a first fastener, the cage including a base portion and an arm portion defining a cavity, the first fastener including a head portion at least partially disposed within the cavity and a threaded shank portion coupled to the head portion, the threaded shank portion extending from the cavity along a longitudinal axis;
fixedly coupling the cage to the first automobile component such that the longitudinal axis extends in a substantially horizontal direction during first and second automobile component assembly;
positioning the threaded shank portion through an aperture of the second automobile component wherein a full weight of the second automobile component is supported by the shank; and
after supporting the second automobile component on the shank, rotating a cooperating threaded fastener onto the threaded shank of the first fastener wherein the first automobile component is fixedly coupled in a desired position relative to the second automobile component.

2. The method of claim 1, wherein rotating a cooperating threaded fastener onto the threaded shank of the first fastener comprises:
a first rotating until the cooperating threaded fastener is loosely positioned against the second automobile component;
repositioning the second automobile component relative to the first automobile component while the first automobile component is loosely positioned against the second automobile component by the cooperating threaded fastener; and
a second rotating until the first automobile component is fixedly coupled in a desired position relative to the second automobile component.

3. The method of claim 1, further comprising riveting the base portion to the first automobile component.

4. The method of claim 3, wherein riveting the base portion to the first automobile component comprises pierce riveting the base portion to the first rivet.

5. The method of claim 1, wherein the second automobile component includes at least a portion of an automobile door.

6. The method of claim 1, wherein the second automobile component includes a radiator.

7. A method of assembling a first automobile component relative to a second automobile component, the method comprising:
providing a cage fastener assembly that includes a cage and a first fastener, the cage including a base portion and an arm portion defining a cavity, the first fastener including a head portion at least partially disposed within the cavity and a threaded shank portion coupled to the head portion, the threaded shank portion extending from the cavity along a longitudinal axis;
fixedly coupling the cage to the first automobile component;
providing an intermediate automobile component over the cage fastener assembly wherein the threaded shank portion visibly extends into the intermediate automobile component while the cage is visibly obscured by the intermediate automobile component;
positioning the threaded shank portion through an aperture of the second automobile component wherein the positioning is aided by visibly locating the threaded shank extending through the intermediate automobile component; and
rotating a cooperating threaded fastener onto the threaded shank of the first fastener wherein the first automobile component is fixedly coupled in a desired position relative to the second automobile component.

8. The method of claim 7, wherein rotating a cooperating threaded fastener onto the threaded shank of the first fastener comprises:
a first rotating until the cooperating threaded fastener is loosely positioned against the second automobile component;
repositioning the second automobile component relative to the first automobile component while the first automobile component is loosely positioned against the second automobile component by the cooperating threaded fastener; and
a second rotating until the first automobile component is fixedly coupled in a desired position relative to the second automobile component.

9. The method of claim 7, wherein positioning the threaded shank portion through an aperture of the second automobile component comprises viewing the shank portion through the aperture of the second automobile component and through an aperture formed in the intermediate automobile component.

10. The method of claim 7, wherein positioning the threaded shank portion through an aperture of the second automobile component comprises compressing the intermediate portion such that the shank portion extends through the intermediate portion.

11. The method of claim 10, wherein the intermediate automobile component is selected from a group consisting of carpet, carpet padding, or both.

12. The method of claim 10, wherein the intermediate automobile component includes an insulation material.

13. The method of claim 17, wherein the second automobile component includes an automobile seat.

14. A method of assembling a first automobile component relative to a second automobile component, the method comprising:
providing a cage fastener assembly that includes a cage and a first fastener, the cage including a base portion and an arm portion defining a cavity, the first fastener including a head portion at least partially disposed within the cavity and a threaded shank portion coupled to the head portion, the threaded shank portion extending from the cavity along a longitudinal axis;
fixedly coupling the cage to the first automobile component such that the longitudinal axis extends in a substantially horizontal direction during first and second automobile component assembly;
positioning the threaded shank portion through an aperture of the second automobile component such that the second automobile component is adjustably coupled to the first automobile component; and
after coupling the second automobile component to the first automobile component, rotating a cooperating threaded fastener onto the threaded shank of the first fastener wherein the first automobile component is fixedly coupled in a desired position relative to the second automobile component.

15. The method of claim 14, wherein rotating a cooperating threaded fastener onto the threaded shank of the first fastener comprises:
a first rotating until the cooperating threaded fastener is loosely positioned against the second automobile component;
repositioning the second automobile component relative to the first automobile component while the first automobile component is loosely positioned against the second automobile component by the cooperating threaded fastener; and
a second rotating until the first automobile component is fixedly coupled in a desired position relative to the second automobile component.

16. The method of claim 14, further comprising riveting the base portion to the first automobile component.

17. The method of claim 16, wherein riveting the base portion to the first automobile component comprises pierce riveting the base portion to the first rivet.

18. A method of assembling a first automobile component relative to a second automobile component, the method comprising:
providing a cage fastener assembly that includes a cage and a first fastener, the cage including a base portion and an arm portion defining a cavity, the first fastener including a head portion at least partially disposed within the cavity and a threaded shank portion coupled to the head portion, the threaded shank portion extending from the cavity along a longitudinal axis;
fixedly coupling the cage to the first automobile component;
providing an intermediate automobile component over the cage fastener assembly wherein the threaded shank portion visibly extends into the intermediate automobile component while the cage is visibly obscured by the intermediate automobile component;
positioning the second automobile component relative to the first automobile component such that the weight of the second automobile component is supported by the shank portion in a direction extending substantially parallel to the longitudinal axis;
positioning the threaded shank portion through an aperture of the second automobile component; and
rotating a cooperating threaded fastener onto the threaded shank of the first fastener wherein the first automobile component is fixedly coupled in a desired position relative to the second automobile component.

19. The method of claim 18, wherein positioning the threaded shank portion through an aperture of the second automobile component comprises viewing the shank portion through the aperture of the second automobile component and through an aperture formed in the intermediate automobile component.

20. The method of claim 18, wherein positioning the threaded shank portion through an aperture of the second automobile component comprises compressing the intermediate portion such that the shank portion extends through the intermediate portion.

21. The method of claim 18, wherein the intermediate automobile component is selected from a group consisting of carpet, carpet padding, or both.

22. A cage fastener assembly comprising:
a cage having a base portion and a pair of arm portions, the base portion and the pair of arm portions defining a cavity therebetween, the base portion defining a first longitudinally extending width, and the arm portions defining a second longitudinally extending width less than the first longitudinally extending width; and
a stud having a head portion and a shank portion, the head portion at least partially disposed within the cavity of the cage, the shank portion extending through the base portion of the cage.

23. The cage fastener assembly of claim 22, wherein the cage is formed from at least one of aluminum and a high strength low alloy steel.

24. The cage fastener assembly of claim 22, wherein the stud includes an ASTM Class 10.9 shank portion.

25. The cage fastener assembly of claim 24, wherein the ASTM 10.9 shank portion is formed from a material selected from the group consisting of an alloy steel, a carbon steel, and a stainless steel.
